(19) United States
(12) Patent Application Publication
(10) Pub. No.: US 2017/0014872 A1
(43) Pub. Date: Jan. 19, 2017

(54) ENERGY-EFFICIENT PROCESS FOR PURIFYING VOLATILE COMPOUNDS AND DEGREASING

(71) Applicant: HONEYWELL INTERNATIONAL INC., MORRIS PLAINS, NJ (US)

(72) Inventors: Jon Thomas Herdlein, Buffalo, NY (US); Anthony Anzalone, Angola, NY (US); Ryan Hulse, Getzville, NY (US); Kane D. Cook, Eggertsville, NY (US)

(21) Appl. No.: 15/205,750

(22) Filed: Jul. 8, 2016

Related U.S. Application Data
(60) Provisional application No. 62/193,832, filed on Jul. 17, 2015.

(51) Int. Cl. B08B 7/00; C11D 11/00; C11D 7/50

(52) U.S. Cl. CPC B08B 7/0021; C11D 7/5086; C11D 11/0023

(57) ABSTRACT

Disclosed is an energy-efficient method for degreasing or defluxing comprising a) providing a heated distillation vessel capable of being operated under positive pressure; b) charging with a solvent comprising HCFO 1233zd; c) heating to provide positive pressure so that solvent boils at about 30-100° C.; d) distilling using an air-cooled heat exchanger; e) releasing the pressure; f) cooling by channeling through an immersion tank subfloor and/or side; g) collecting the solvent; h) performing degreasing operations; and i) pumping soiled solvent back to the heated distillation vessel. Also disclosed are an energy-efficient method for purifying volatile compounds, and pressurized solvent degreasing system capable of use with HCFO 1233zd.

### CROSS REFERENCE TO RELATED APPLICATIONS

The present application is related to and claims the priority benefit of U.S. Provisional Application 62/193,832, filed Jul. 17, 2015, which is incorporated herein by reference.

### FIELD OF THE INVENTION

The present invention relates, generally, to systems for degreasing and/or defluxing having improved energy efficiency, and methods of degreasing and/or defluxing.

### BACKGROUND OF THE INVENTION

Solvent vapor phase degreasing and defluxing is a process of immersing a soiled substrate or part (e.g., a printed circuit board or a fabricated metal, glass, ceramic, plastic, or elastomer part or composite) or a portion of a substrate or part into a boiling, nonflammable liquid such as a chlorocarbon or chlorofluorocarbon fluid or admixture, followed by rinsing the part in a second tank or cleaning zone by immersion or distillate spray with a clean solvent which is the same chlorocarbon or chlorofluorocarbon as used in the first cleaning zone. The parts are then dried by maintaining the cooled part in the condensing vapors until temperature has reached equilibrium.

Solvent cleaning of various types of parts generally occurs in batch, hoist-assisted batch, conveyor batch, or in-line type conveyor degreaser and defluxer equipment. Parts may also be cleaned in open top defluxing or degreasing equipment. In both types of equipment, the entrance and/or exit ends of the equipment are generally in open communication with both the ambient environment and the solvent within the equipment. In order to minimize the loss of solvent from the equipment by either convection or diffusion, a common practice in the art is to use water-cooled or refrigerant-cooled coils which create a condensed vapor blanket over a hot or ambient zone region in the degreaser/defluxer tank. The necessity for refrigerant cooling introduces the burden of cost for refrigeration equipment (installation, maintenance and operation), including the energy input required for the degreasing operation itself.

Further, operator handling and environmental issues are associated with the refrigerant chemical itself. Certain single organic chlorocarbons or chlorofluorocarbons (CFCs) fluids are known for use into the cleaning, rinsing, and drying steps. The use of CFC-113 and Freon-type solvents has been, in the past, particularly popular. However, the vapor diffusion thereof into the environment has been implicated to be one of many possible contributing causes to the undesirable global depletion of stratospheric ozone. In response to environmental concern, certain hydrochlorofluorocarbon (HCFC) based solvents have been developed to provide more environmentally acceptable alternatives to the CFC-based vapor phase degreasing and defluxing processes. While these certain materials have been shown to be excellent substitutes for a variety of cleaning applications, they are considered to be only an interim replacement for previously used CFCs since they still possess a small, but finite, ozone depletion potential, although it is much lower than that of the CFCs which they are replacing. Hence, those certain HCFC solvents are also proposed for global phaseout in the near future. It is generally believed that organic solvents which do not contain chlorine, bromine, or iodine atoms will not contribute to stratospheric ozone depletion. However, many organic chemicals which do not contain the above halogen atoms, such as hydrocarbons, alcohols, esters, ethers, ketones, etc., possess undesirable flammability or reactivity properties. Certain perfluorinated saturated hydrocarbons and hydrofluorocarbons are thought to possess many desirable solvent properties, such as: zero ozone depletion potential; stability, non-reactivity, and high compatibility with plastics; good water displacement potential; and low toxicity and general inertness. However, these certain perfluorocarbons have been found to be very poor solvents for many common organic and inorganic soils, e.g., fluxes.

Applicants have come to appreciate the need for more energy-efficient degreasing systems and methods, as well as the need for systems and methods which mitigate the issues and hazards associated with Freon-type solvents.

### SUMMARY OF INVENTION

The energy- and other-efficient degreasing systems and methods of the present invention provide solutions to these needs and issues. Thus, one aspect of the invention is directed to methods and/or systems for cleaning or removing one or more contaminant(s) from a device or article, or a part or portion of a device or article. The preferred methods included the step of providing a solvent composition in a vapor phase that is at least partially condensable at a temperature that is at least about 10° F. greater than, more preferably in certain embodiments at least about 15° F. greater than, and even more preferably in certain embodiments, at least about 20° F. greater than ambient temperature and/or the temperature of available cooling air. According to preferred system aspects of the invention, the systems comprise a condensing temperature regulation device/subsystem which provides a liquid stream and/or reservoir of solvent and which is capable of producing from said solvent stream or reservoir a solvent vapor phase that is at least partially condensable at a temperature that is at least about 10° F. greater than, more preferably in certain embodiments at least about 15° F. greater than, and even more preferably in certain embodiments, at least about 20° F. greater than ambient temperature and/or the temperature of available cooling air. In preferred embodiments, the condensing temperature regulation device/subsystem achieves the desired vapor at the relatively elevated temperature by regulating the pressure in the vapor space containing said solvent vapor such that evaporation of the portion of the liquid stream and/or reservoir of solvent produces a vapor having the desired increased temperature.

One advantage of the methods and systems of the preferred embodiments of present invention is that it permits a highly desirable reduction in operating and/or capital costs by eliminating the necessity for providing the refrigeration equipment and/or the cost of operating such equipment which has heretofore normally been required to condense volatile solvents at atmospheric or reduced pressure (vacuum) according prior art methods and systems.

In certain preferred embodiments, the methods and systems of the present invention achieve the desired temperature in the vapor phase of the solvent by adding heat to the liquid solvent contained in a pressure vessel and/or conduit and regulating the pressure in the vapor space in such vessel and/or conduit such that the corresponding temperature thereof is increased sufficient to create the desired temperature differential with available ambient and/or cooling air or gas. According to such preferred aspects of the invention, ambient air, or other higher temperature gas or fluid that might be available as a waste heat sink, can be used to produce the heat transfer medium instead of a refrigeration cycle. Moreover, the inventive system in preferred embodiments also removes or reduces the cost of any associated refrigerant chemical. The volatile solvents used according to preferred aspects of the present invention do not require as much heat to boil and, therefore, their use reduces energy consumption. In addition to reducing operation costs, system reliability is also improved by potentially removing the refrigeration compressor, a moving part that is susceptible to failure. Thus, the inventive degreasing/defluxing system has advantages that include but are not limited to; (a) removing or reducing the cost of any refrigeration equipment (installation, maintenance and operation); removing or reducing the handling and environmental issues associated with the refrigerant chemical; and also reducing the energy input required for the degreasing operation itself.

One aspect of the invention is directed to an energy-efficient method for purifying volatile compounds or solvents comprising: a) providing a vessel capable of operating operate under positive pressure; b) charging the vessel with a low-boiling solvent composition in need of purification, to provide a charged vessel; c) heating the charged vessel to vaporize at least a portion of said solvent composition, said heating also producing sufficient pressure so that the low-boiling, solvent composition boils at at least one temperature in the region of from about 30° C. to about 100° C., more preferably from about 50° C. to about 100° C.; and d) removing at least a portion of the solvent composition under pressure using a low-energy condensing means to provide a purified compound or mixture. In one embodiment the method further comprises the step of releasing the pressure to ambient pressure to collect the purified volatile compound or solvent. In one embodiment the low-energy condensing means comprises an ambient-air-cooled heat exchanger. In a preferred embodiment the low-boiling compound or solvent comprises 1-chloro-3,3,3-trifluoropropene. In another preferred embodiment the low-boiling mixture comprises an azeotropic mixture or azeotrope-like mixture comprising 1-chloro-3,3,3-trifluoropropene and an alcohol selected from the group consisting of methanol, ethanol and isopropanol. In one embodiment of the method, the energy usage of the process is at least about 20% less than the analogous process operated under ambient pressure. In one embodiment of the method, the energy usage of the process is about 20% to about 40% less than the process operated under ambient pressure.

Another aspect of the invention is directed to energy-efficient methods for degreasing or defluxing, comprising: a) providing a heated distillation vessel capable of operating under positive pressure; b) charging the vessel with a solvent comprising 1-chloro-3,3,3-trifluoropropene to provide a charged vessel; c) heating the charged vessel to produce sufficient pressure so that the solvent boils at a temperature of about 30° C. to about 100° C., more preferably from about 50° C. to about 100° C.; d) distilling the solvent under pressure using a low-energy condensing means comprising an ambient-air-cooled heat exchanger to provide purified solvent; e) releasing the pressure to ambient pressure providing depressurized purified solvent; f) cooling the depressurized purified solvent by channeling through an immersion tank subfloor and/or side; g) collecting the cooled solvent in liquid form in an immersion bath in the immersion tank; h) performing degreasing or defluxing operations in the immersion tank to form soiled solvent; and i) pumping the soiled solvent back into said heated distillation vessel. In one embodiment of the method the solvent comprises an azeotropic mixture or azeotrope-like mixture comprising 1-chloro-3,3,3-trifluoropropene and an alcohol selected from the group consisting of methanol, ethanol and isopropanol. In one embodiment of the method, the energy usage of the process is at least about 20% less than the analogous process operated under ambient pressure. In one embodiment of the method, the energy usage of the process is about 20% to about 40% less than the process operated under ambient pressure.

Another aspect of the invention is directed to a pressurized solvent degreasing system capable of use with 1-chloro-3,3,3-trifluoropropene, the system comprising: a) a heated distillation or purification vessel capable of operating under positive pressure; connected to b) an ambient-air-cooled heat exchanger; connected to c) a back pressure regulator capable of dropping the pressure to ambient pressure; connected to d) a degreasing tank comprising an immersion tank, and a subfloor-channel and/or side-channel for cooling distilled solvent; wherein the immersion tank is connected to e) a return pump to return solvent into said heated distillation or purification vessel. In one embodiment the degreasing system further comprises a low-boiling solvent or solvent mixture. In a preferred embodiment the low-boiling solvent comprises 1-chloro-3,3,3-trifluoropropene. In another preferred embodiment the low-boiling solvent comprises an azeotropic mixture or azeotrope-like mixture of 1-chloro-3,3,3-trifluoropropene and an alcohol selected from the group consisting of methanol, ethanol and isopropanol. In one embodiment the degreasing system operates at a positive pressure of from about 20 to about 50 psig. In one embodiment of the degreasing system, the energy usage of the system is at least about 20% less than the analogous system operated under ambient pressure. In one embodiment of the degreasing system, the energy usage of the system is about 20% to about 40% less than for the analogous system operated under ambient pressure.

A further aspect of the present invention is directed to an energy-efficient degreasing system using degreasing solvent compositions that include (a) a first component comprising an alcohol selected from the group consisting of methanol, ethanol and isopropanol, (b) a second component selected from the group consisting of a glycol ether, a terpene, a halogenated hydrocarbon, and combinations thereof, and (c) a third component selected from the group consisting of a hydrofluorocarbon (other than the halogenated hydrocarbon second component), a hydrohaloether, a decahalopentane, and combinations thereof, wherein the second and third components are not the same. In additional aspects, the third component is provided in an amount effective to form an azeotrope or azeotrope-like composition with at least one alcohol of the first component.

In certain embodiments, the second degreasing solvent component includes a halogenated hydrocarbon, which may be provided in the amounts herein. The halogenated hydrocarbon may include a hydrocarbon chain selected from the group consisting of a C₁ to C₈ alkyl group, a C₂ to C₈ alkenyl group, a C₁ to C₈ alcohol group, a C₂ to C₁₀ ether, and a C₅ to C₇ cyclic alkenyl group, which is substituted with at least one halogen selected from F, Cl, Br, or I. In certain embodiments, the halogenated hydrocarbon is substituted with at least one Cl. In further embodiments, it is selected from the group consisting of trans-1,2-dichloroethylene, perchloroethylene, trichloroethylene, and combinations thereof.

In certain embodiments, the second degreasing solvent component includes a glycol ether, which may be provided in the amounts herein. The glycol ether may include the structure R′O—R—OR′. R is selected from a C₁ to C₈ alkyl group, a C₂ to C₈ alkenyl group, a C₁ to C₈ alcohol group, or a C₂ to C₁₀ ether group, a C₅ to C₇ cyclic alkyl group, a C₅ to C₇ cyclic alkenyl group, a C₅ to C₇ heterocyclic alkyl group, or a C₅ to C₇ heterocyclic alkenyl group, and each R′ is independently selected from an H, a C₁ to C₈ alkyl group, a C₂ to C₈ alkenyl group, a C₁ to C₈ alcohol group, or a C₂ to C₁₀ ether group, a C₅ to C₇ cyclic alkyl group, a C₅ to C₇ cyclic alkenyl group, a C₅ to C₇ heterocyclic alkyl group, or a C₅ to C₇ heterocyclic alkenyl group. In certain embodiments, R comprises a C₁-C₄ alkyl group. In further embodiments, the glycol ether is comprised of the structure R′—O—(CH₂)₂—O—R′, particularly where at least one R′ is H and the other R′ is selected from the group consisting of a C₁ to C₈ alkyl group, a C₂ to C₈ alkenyl group, a C₁ to C₈ alcohol group, a C₂ to C₁₀ ether, and a C₅ to C₇ cyclic alkenyl group. In even further embodiments, the glycol ether is selected from the group consisting of ethylene glycol monobutyl ether, 2-ethoxyethanol, 2-methoxyethanol, 2-propxyethanol, 2-phenoxyethanol, 2-benzoxy ethanol, methyl carbitol, carbitol cellosolve, diethoxyethane, dimethoxyethane, dibutoxybutane, dipropylene glycol methyl ether, dipropylene glycol mono n-butyl ether, dipropylene glycol monomethyl ether acetate, propylene glycol monomethyl ether, propylene glycol monomethyl ether acetate, and/or propylene glycol phenyl ether.

In certain embodiments, the second degreasing solvent component includes a terpene, which may be provided in the amounts disclosed herein. While the terpene may be any of or combination of terpenes provided herein, in certain preferred aspects the terpene is d-Limonene and/or pinene.

The third degreasing solvent component may include a hydrohaloether. In certain aspects, the hydrohaloether has the structure R—O—R′, wherein R and R′ are each independently selected from the group consisting of a C₁ to C₂₀ alkyl group, C₂ to C₂₀ alkenyl group, C₁ to C₂₀ alcohol group, C₂ to C₂₀ ether group, C₅ to C₇ cyclic alkyl group, C₅ to C₇ cyclic alkenyl group, C₅ to C₇ heterocyclic alkyl group, or C₅ to C₇ heterocyclic alkenyl group, where at least one of R and/or R′ is substituted at one or more positions with a halogen atom. In certain preferred embodiments, the hydrohaloether is a hydrofluoroether, wherein in certain embodiments it has or includes the substructure —CH₂OCF₂CF₂CF₂CF₃. The hydrohaloether may be provided in an amount from about 25 weight percent to about 99 weight percent, in certain embodiments, in an amount from about 50 weight percent to about 99 weight percent, in certain embodiments in an amount from about 75 weight percent to about 99 weight percent, in certain embodiments in an amount from about 90 weight percent to about 99 weight percent, and in certain embodiments in an amount from about 92 weight percent to about 96 weight percent.

The third degreasing solvent component may also (or alternatively) include a decahalopentane, which in certain embodiments is a decafluoropentane. The decafluoropentane may be selected from the group consisting of 1,1,1,2,2,3,4,5,5,5-decafluoropentane (which is equivalent to 1,1,1,2,3,4,4,5,5,5-decafluoropentane), and/or 1,1,1,2,3,3,4,5,5,5-decafluoropentane. The decahalopentane may be provided in an amount from about 30 weight percent to about 99 weight percent, in certain embodiments, in an amount from about 50 weight percent to about 99 weight percent, in certain embodiments in an amount from about 70 weight percent to about 99 weight percent, in certain embodiments in an amount from about 90 weight percent to about 99 weight percent, and in certain embodiments in an amount from about 92 weight percent to about 96 weight percent.

Certain aspects of the invention are also directed to methods for removing residual soils or surface contamination from a part employing the energy-efficient degreasing systems described herein. Such methods may include immersing the part in a solvent composition comprising the components as described herein. The solvent composition is heated under positive pressure to form a flammability-suppression blanket comprising (a) above and a substantial absence of the second component. The part is then dried within the flammability-suppression blanket.

To assist in the formation of the vapor blanket, the second component may have a boiling point that is at least 10° C. higher, in certain aspects at least 25° C. higher, and in further aspects at least 50° C. higher than the first and third components and/or any azeotrope or azeotrope-like compositions formed therebetween.

Additional embodiments and advantages to the invention will be readily apparent on the basis of the disclosure provided.

### BRIEF DESCRIPTION OF THE FIGURES

FIG. 1 presents a schematic drawing of a condensing manipulator system according to one embodiment of the invention.

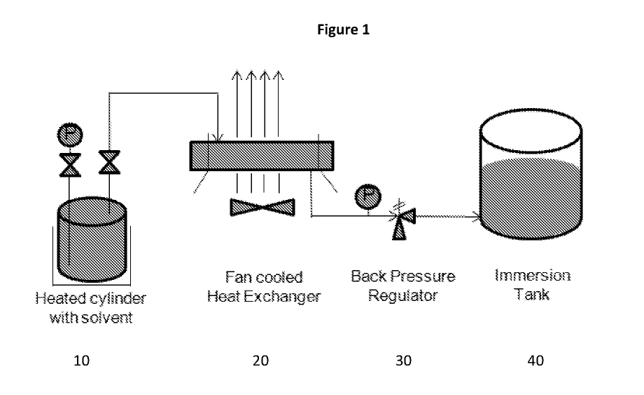

FIG. 2 presents a schematic drawing of a pressurized solvent degreasing/defluxing system according to one embodiment of the invention.

### DETAILED DESCRIPTION

It has now been discovered that a pressurized solvent degreasing system embodying a condensing manipulator and capable of use with the specific low-boiling solvent 1-chloro-3,3,3-trifluoropropene (HCFO 1233zd) is surprisingly energy-efficient. The pressurized solvent degreasing system capable of use with 1-chloro-3,3,3-trifluoropropene, said system comprises: a) a heated vessel for containing solvent comprising said 1-chloro-3,3,3-trifluoropropene, preferably in certain embodiments a distillation vessel, having a reboiler or other means to add heat to at least a portion of liquid contained and to produce a pressurized vapor space therein, said vessel capable of operating under positive pressure; connected to b) an ambient-air-cooled heat exchanger; connected to c) a back pressure regulator capable of dropping the pressure to ambient pressure; connected to d) a degreasing tank comprising an immersion tank, and in certain preferred embodiments a subfloor-channel and/or side-channel for cooling distilled solvent; wherein the immersion tank is connected to e) means to return liquid solvent to the vessel, said means in preferred embodiments comprising a return pump and a conduit to return solvent into the vessel.

Certain embodiments of the invention are directed to systems and methods are directed to the use of a condensing manipulator, such as a back pressure valve, in solvent purification or degreaser applications, which reduces operating costs by eliminating the necessity for refrigeration means normally required to condense volatile solvents at atmospheric or reduced pressure (vacuum). The preferred condensing manipulator will generally be used in conjunction with the pressure vessel. In order to change the phase state of the solvent vapor that is produced in the pressure vessel, at a minimum, sufficient heat must be removed to condense the vapor, preferably using a heat exchanger or similar devise. Under positive pressure, the operating temperatures of the system can be increased thereby creating a larger temperature differential and allowing ambient air to function as the heat transfer medium instead of a refrigeration cycle. For example, for a 10 gallon degreaser approximately 1500 to 2500 watts of operating heat duty can be removed from the total sub-ambient refrigeration requirement by performing the operation under positive pressure and using higher temperature fluids to remove at least a portion of the heat needed to condense the vapor. Moreover, the inventive design also removes the cost of the associated refrigerant chemical. More volatile solvents do not require as much heat to boil (i.e., the sensible heat input is minimal) and, therefore, their use reduces energy consumption by reducing the energy required to form the solvent vapor. In addition to reducing operation costs, system reliability is also improved by removing or reducing the size of the refrigeration compressor, a moving part that is susceptible to failure. Thus, preferred aspects of the present invention not only remove all or a substantial portion of the cost of refrigeration equipment (installation, maintenance and operation), but preferably removes or at least reduces the handling and environmental issues associated with the refrigerant chemical. In preferred embodiments, the energy input required for the degreasing operation itself is reduced substantially.

The term “HCFO-1233zd” refers to the compound 1-chloro-3,3,3-trifluoropropene, independent of whether it is the cis- or trans-form. The terms “cis-HCFO-1233zd” and “trans-HCFO-1233zd”, or alternatively, “HCFO-1233zd (Z)” and “HCFO-1233zd (E)”, are used to describe the cis- and trans-forms of 1-chloro-3,3,3-trifluoropropene, respectively. The term “HCFO-1233zd” therefore includes within its scope cis-HCFO-1233zd (HCFO-1233zd (Z)), trans-HCFO-1233zd (HCFO-1233zd (E)), and all combinations and mixtures of these.

The term “cis-HCFO-1233zd” means that the amount of cis-HCFO-1233zd relative to all isomers of HCFO-1233zd is at least about 95%, more preferably at least about 98%, even more preferably at least about 99%, even more preferably at least about 99.9%. In certain preferred embodiments, the cis-HCFO-1233zd component is essentially pure cis-HCFO-1233zd.

The term “trans-HCFO-1233zd” means that the amount of trans-HCFO-1233zd relative to all isomers of HCFO-1233zd is at least about 95%, more preferably at least about 98%, even more preferably at least about 99%, even more preferably at least about 99.9%. In certain preferred embodiments, the trans-HCFO-1233zd component is essentially pure trans-HCFO-1233zd.

One aspect of the invention is directed to an energy-efficient method for purifying volatile compounds or solvents comprising: a) providing a vessel, in certain embodiments a distillation vessel, capable of operating under positive pressure and capable of having heat added to the contents thereof; b) charging the vessel with a low-boiling compound, solvent or mixture in the liquid state and in need of purification, to provide a charged vessel; c) heating at least a portion of the contents of the charged vessel to produce sufficient pressure so that the low-boiling compound, solvent or mixture boils at a temperature of from about 30° C. to about 100° C., more preferably from about 50° C. to about 100° C. and thereby forming a vapor in said vessel containing the compound, solvent or mixture under pressure; and condensing said vapor at an elevated pressure using a low-energy heat sink, which in certain preferred embodiments provides a purified compound or mixture in liquid form.

In one embodiment the boiling point of the solvent or mixture under pressure is from about 55° C. to about 95° C.; in another embodiment the boiling point is about 60 to about 90° C.; in another embodiment the boiling point is from about 65° C. to about 85° C.; in another embodiment the boiling point is from about 70° C. to about 80° C.; in one embodiment the boiling point is about 75° C. The boiling point of the solvent or mixture under pressure can also be selected to be about 50° C., about 55° C., about 60° C., about 65° C., about 70° C., about 80° C., about 85° C., about 90° C. about 95° C. or about 100° C.

In certain embodiments the methods further comprises the step of reducing the pressure of the vapor, preferably in certain embodiments to about ambient pressure, to obtain the volatile compound or solvent in liquid form, preferably as a relatively purified liquid.

In one embodiment the low-energy condensing means comprises an ambient-air-cooled heat exchanger. This heat exchanger can also comprise a fan. In a preferred embodiment the low-boiling compound or solvent comprises 1-chloro-3,3,3-trifluoropropene. In another preferred embodiment the low-boiling mixture comprises an azeotropic mixture or azeotrope-like mixture comprising 1-chloro-3,3,3-trifluoropropene and an alcohol selected from the group consisting of methanol, ethanol and isopropanol. In one embodiment of the method, the energy usage of the process is at least about 20% less than the analogous process operated under ambient pressure. In one embodiment of the method, the energy usage of the process is about 20% to about 40% less than the process operated under ambient pressure; in one embodiment the energy usage is about 20% to about 30% less; in another embodiment the energy usage is about 30% to about 40% less. In one embodiment of the method, the energy usage is about 20% less; in one embodiment the energy usage is about 25% less; in one embodiment the energy usage is about 30% less; in one embodiment the energy usage is about 35% less; in one embodiment the energy usage is about 40% less.

Another aspect of the invention is directed to energy-efficient method for degreasing or defluxing, comprising: a) providing a heated distillation vessel capable of operating under positive pressure; b) charging the vessel with a solvent comprising 1-chloro-3,3,3-trifluoropropene to provide a charged vessel; c) heating the charged vessel to produce sufficient pressure so that the solvent boils at a temperature of about 30° C. to about 100° C., more preferably from about 50° C. to about 100° C.; d) distilling the solvent under pressure using a low-energy condensing means comprising an ambient-air-cooled heat exchanger to provide purified solvent; e) releasing the pressure to ambient pressure providing depressurized purified solvent; f) cooling the depressurized purified solvent by channeling through an immersion tank subfloor and/or side; g) collecting the cooled solvent in liquid form in an immersion bath in the immersion tank; h) performing degreasing or defluxing operations in the immersion tank to form soiled solvent; and i) pumping the soiled solvent back into said heated distillation vessel. In one embodiment the boiling point of the solvent or mixture under pressure is about 55 to about 95° C.; in another embodiment the boiling point is about 60 to about 90° C.; in another embodiment the boiling point is about 65 to about 85° C.; in another embodiment the boiling point is about 70 to about 80° C.; in one embodiment the boiling point is about 75° C. The boiling point of the solvent or mixture under pressure can also be selected to be about 50, about 55, about 60, about 65, about 70, about 80, about 85, about 90 about 95 or about 100° C. In one embodiment of the method the solvent comprises an azeotropic mixture or azeotrope-like mixture comprising 1-chloro-3,3,3-trifluoropropene and an alcohol selected from the group consisting of methanol, ethanol and isopropanol. In one embodiment of the method, the energy usage of the process is at least about 20% less than the analogous process operated under ambient pressure. In one embodiment of the method, the energy usage of the process is about 20% to about 40% less than the process operated under ambient pressure; in one embodiment the energy usage is about 20% to about 30% less; in another embodiment the energy usage is about 30% to about 40% less. In one embodiment of the method, the energy usage is about 20% less; in one embodiment the energy usage is about 25% less; in one embodiment the energy usage is about 30% less; in one embodiment the energy usage is about 35% less; in one embodiment the energy usage is about 40% less.

Another aspect of the invention is directed to a pressurized solvent degreasing system capable of being used with 1-chloro-3,3,3-trifluoropropene, the system comprising: a) a heated distillation vessel capable of operating under positive pressure; connected to b) an ambient-air-cooled heat exchanger; connected to c) a back pressure regulator capable of dropping the pressure to ambient pressure; connected to d) a degreasing tank comprising an immersion tank, and a subfloor-channel and/or side-channel for cooling distilled solvent; wherein the immersion tank is connected to e) a return pump to return solvent into said heated distillation vessel. In one embodiment the degreasing system, further comprises a low-boiling solvent or solvent mixture. In a preferred embodiment the low-boiling solvent comprises 1-chloro-3,3,3-trifluoropropene. In another preferred embodiment the low-boiling solvent comprises an azeotropic mixture or azeotrope-like mixture of 1-chloro-3,3,3-trifluoropropene and an alcohol selected from the group consisting of methanol, ethanol and isopropanol. In one embodiment the degreasing system operates at a positive pressure of about 20 to about 50 psig. In one embodiment the positive pressure is about 25 to about 45 psig; in another embodiment the positive pressure is about 30 to about 40 psig; in another embodiment the positive pressure is about 35 psig. The positive pressure may be selected from about 20, about 25, about 30, about 35, about 40, about 45 or about 50 psig. In one embodiment of the degreasing system, the energy usage of the system is at least about 20% less than the analogous system operated under ambient pressure. In one embodiment of the degreasing system, the energy usage of the system is about 20% to about 40% less than for the system operated under ambient pressure; in one embodiment the energy usage is about 20% to about 30% less; in another embodiment the energy usage is about 30% to about 40% less. In one embodiment of the degreasing system, the energy usage of the system is about 20% less; in one embodiment the energy usage is about 25% less; in one embodiment the energy usage is about 30% less; in one embodiment the energy usage is about 35% less; in one embodiment the energy usage is about 40% less.

The alcohol may refer to any component having an alcohol group attached thereto. In certain non-limiting embodiments, the alcohols include a C₁-C₃ alcohol, and in certain preferred embodiments the alcohol comprises at least one of methanol, ethanol, or isopropanol.

As used herein, the term “halogenated hydrocarbons” refers to a hydrocarbon chain or ring where at least one position is substituted with a halogen atom. The hydrocarbon chain may include a C₁ to C₂₀ alkyl group, a C₂ to C₂₀ alkenyl group, a C₁ to C₂₀ alcohol group, a C₂ to C₂₀ ether, a C₅ to C₇ cyclic alkenyl group, a C₅ to C₇ heterocyclic alkyl group, or C₅ to C₇ heterocyclic alkenyl group, any of which may be straight or branched chained (if applicable) and/or optionally substituted at one or more positions. In certain aspects, it includes a C₁ to C₈ alkyl group, a C₂ to C₈ alkenyl group, a C₁ to C₈ alcohol group, a C₂ to C₁₀ ether, or a C₅ to C₇ cyclic alkenyl group, any of which may be straight or branched chained (if applicable) and/or optionally substituted at one or more positions. In any of the foregoing embodiments, the hydrocarbon is preferably substituted with at least one halogen selected from F, Cl, Br, or I.

In certain embodiments, the halogenated hydrocarbon is a C₁ to C₅ alkyl group or a C₂ to C₅ alkenyl group. In further embodiments, it is a C₂ alkenyl group that contains at least one chlorine atom. Non-limiting examples of such solvents include, trans-1,2-dichloroethylene, perchloroethylene, trichloroethylene, and combinations thereof. In certain aspects, the halogenated hydrocarbon used as the second component does not include a decahalopentane, particularly a decafluoropentane.

The alcohol(s) provided in the first component may be collectively provided in an amount from greater than about 0 weight percent to about 15 weight percent, based on the total weight of the composition. In certain aspects, the first component is provided in an amount from about 0.01 weight percent to about 10 weight percent, based on the total weight of the composition. In certain preferred embodiments, the first component is provided in an amount from about 1 weight percent to about 5 weight percent, based on the total weight of the composition.

When the second component is a halogenated hydrocarbon, it may be provided in an amount from greater than about 0 weight percent to about 50 weight percent, from about 0.01 weight percent to about 40 weight percent, or from about 1 weight percent to about 30 weight percent, based on the total weight of the composition.

When the second component is trans-1,2-dichloroethylene, it may be provided in an any amount from about 1 to about 99%, from greater than about 5 weight percent to about 50 weight percent, from about 6 weight percent to about 30 weight percent, and in certain embodiments from about 6 weight percent to about 20 weight percent, based on the total weight of the composition. In certain preferred embodiments, the trans-1,2-dichloroethylene is provided in an amount from about 6 weight percent to about 35 weight percent, based on the total weight of the composition.

These additional component(s) may be provided in any effective amount to effectuate the advantages, methods, or uses discussed herein. In certain non-limiting embodiments, such second components are non-azeotropic with any of the first or third components or are provided in amounts to be non-azeotropic with such components.

In one embodiment, the third component is a hydrohaloether. As used herein, a hydrohaloether refers to a class of solvents having the structure R—O—R′. R and R′ may be independently is selected from a C₁ to C₂₀ alkyl group, C₂ to C₂₀ alkenyl group, C₁ to C₂₀ alcohol group, C₂ to C₂₀ ether group, C₅ to C₇ cyclic alkyl group, C₅ to C₇ cyclic alkenyl group, C₅ to C₇ heterocyclic alkyl group, or C₅ to C₇ heterocyclic alkenyl group, where any of the foregoing (if applicable) may be straight or branch chained and at least one group is substituted at one or more positions with a halogen atom.

In certain preferred embodiments, the hydrohaloether is a hydrofluoroether, which may include monomic or polymerized structures in accordance with the foregoing, where one or more of the R or R′ substituent groups is substituted with a fluorine atom. In certain non-limiting embodiments the hydrofluoroether includes at least one nonafluoro alkyl ether, wherein the alkyl may include 1-10 carbon atoms. In certain non-limiting embodiments, the nonafluoro alkyl ether includes a nonafluor butyl ether and/or a nonafluoro isobutyl ether, including, but not limited to, those commercially available under the tradename NOVEC®, particularly though not exclusively NOVEC® 7200 (available from 3M). In certain non-limiting embodiments, the hydrohaloether has or otherwise includes the following structure CH₃OCF₂CF₂CF₂CF₃, (CF₃)₂CFCF₂OCH₃, CH₃OCF₂CF₂CF₃ or any combination of these with trans-1,2-dichloroethylene.

In further embodiments, the third component includes a decahalopentane. As used herein, a “decahalopentane” means a five carbon alkyl chain substituted with 10 halogen atoms, which may be selected from F, Cl, Br, or I. In certain preferred embodiments, the decahalopentane is a decafluoropentane. Non-limiting examples of such a compound include 1,1,1,2,3,4,4,5,5,5-decafluoropentane (which is equivalent to 1,1,1,2,2,3,4,5,5,5-decafluoropentane), and/or 1,1,1,2,3,3,4,5,5,5-decafluoropentane. In certain embodiments, the decahalopentane or decafluoropentane includes at least one such compound commercially available under the tradename VERTREL® (available from DuPont), including, but not limited to, VERTREL SFR and/or VERTREL XF.

In certain aspects, such third components are provided in an amount from greater than 0.01 weight percent to about 99 weight percent, based on the total weight of the composition. In certain aspects, the third component is provided in an amount from about 25 weight percent to about 99 weight percent, or in certain embodiments from about 20 weight percent to about 99 weight percent, based on the total weight of the composition. In certain preferred embodiments, the third component is provided in an amount from about 50 weight percent to about 99 weight percent, based on the total weight of the composition. In certain preferred embodiments, the third component is provided in an amount from about 70 weight percent to about 99 weight percent, or the third component is provided in an amount from about 75 weight percent to about 99 weight percent, based on the total weight of the composition. In even further embodiments, the third component is provided in an amount from about 90 weight percent to about 99 weight percent, and in certain embodiments the third component is provided in an amount from about 92 weight percent to about 96 weight percent, based on the total weight of the composition.

In certain embodiments, the first and third components form azeotrope-like compositions. As used herein, the term “azeotrope-like” relates to compositions that are strictly azeotropic or that generally behave like azeotropic mixtures. An azeotropic mixture is a system of two or more components in which the liquid composition and vapor composition are equal at the stated pressure and temperature. In practice, this means that the components of an azeotropic mixture are constant-boiling or essentially constant-boiling and generally cannot be thermodynamically separated during a phase change. The vapor composition formed by boiling or evaporation of an azeotropic mixture is identical, or substantially identical, to the original liquid composition. Thus, the concentration of components in the liquid and vapor phases of azeotrope-like compositions change only minimally, if at all, as the composition boils or otherwise evaporates. In contrast, boiling or evaporating non-azeotropic mixtures changes the component concentrations in the liquid phase to a significant degree.

In any of the foregoing embodiments, the second component is added to form the compositions of the present invention. In certain preferred, but non-limiting aspects, the second component is a solvent, particularly a solvent capable to functioning in accordance with the methods and advantages discussed herein. In certain non-limiting aspects, the solvent is capable of, at least partially, solubilizing solder flux and other residues associated with print circuit board manufacture or removal of residues (such as oils and greases) from metallic or non-metallic substrates. In further embodiments, the second component is a high boiling point solvent compound. As used herein, the term “high boiling point solvent” refers to solvent compounds having a boiling point that is greater than the boiling points of at least the first and third components discussed above and/or any azeotrope or azeotrope-like composition formed with such components. In certain preferred embodiments, the “high boiling point” compounds have a boiling point that is at least 10° C. greater than, in certain preferred embodiments at least 25° C. greater than, and in certain preferred embodiments at least 50° C. or more than at least the boiling points of the first and third components and/or any azeotrope or azeotrope-like composition formed therewith.

Many additional compounds or components, including surfactants, lubricants, stabilizers, metal passivators, corrosion inhibitors, flammability suppressants, and other compounds and/or components that modulate a particular property of the compositions (such as cost or flammability for example) may be included in the present compositions. To this end, the presence of all such compounds and components is within the broad scope of the invention.

Applicants have surprisingly and unexpectedly discovered that the combination of the energy efficient degreasing/defluxing system operating under positive pressure as described herein, in specific combination with a solvent comprising 1-chloro-3,3,3-trifluoropropene (HCFO-1233zd) is so energy efficient that there is an energy savings of about 20% to about 40%, based on comparison with the analogous system operating under atmospheric pressure. Further, Applicants have recognized that these systems and methods tend to exhibit relatively low global warming potentials (“GWPs”), preferably less than about 1000, more preferably less than about 500, and even more preferably less than about 150 more close to less than 10.

In certain preferred embodiments of the invention, the systems and methods described herein can be used as a solvent in cleaning various soils such as mineral oil, rosin based fluxes, silicon oils, lubricants, etc., from various substrates by wiping, vapor degreasing, or other means. In other embodiments, the compositions of the present invention are used in a vapor degreaser machine, particularly to remove solder flux and other residues from printed circuit board and/or oil- or grease-based residues from metallic or non-metallic surfaces.

Additional features and advantages will be readily apparent to the skill artisan based on the disclosure provided herein. The following examples are provided to illustrate certain embodiments of the invention. They are not necessarily limiting to the invention. To this end, modifications of such embodiments will be readily apparent to the skilled artisan at least on the basis of the disclosure provided.

### EXAMPLES

### Example 1

### Solvent Recovery and Clean-Up at Room Temperature

A system according to one embodiment of the present invention ins is illustrated Aa pressure container (pressure cylinder), vessel 10, fitted with a pressure gauge and valves was charged with a volatile solvent, such as 1-chloro-3,3,3-trifluoropropene (HCFO-1233zd). A heating blanket was wrapped around the cylinder and a hose was connected to the vapor space of the cylinder. This hose was connected to an ambient air-cooled heat exchanger, 20, which was in turn connected to a back pressure regulator valve with a pressure gauge, 30. The back pressure valve was initially adjusted to control system pressure at 30 psig. Ambient temperature of the air was approximately 70° F. The back pressure regulator was connected directly to the drain valve of an existing degreasing sump/immersion tank, 40, filled with the same solvent.

The cylinder was heated and the pressure inside the system began to increase. The air-cooled heat exchanger fan was turned on as soon as heating was initiated. The tubing connecting the air-cooled heat exchanger and the back pressure regulating valve was translucent so that liquid formation could be observed. As the pressure increased, liquid began to be observed in the translucent tubing at approximately 20 psig. When 30 psig was reached, the back pressure regulating valve opened and flow of clean solvent could be seen inside the vapor degreasing sump, 40. Pressure was maintained at 30 psig and the temperature of the vapor exiting the vessel at this pressure was about 120° F. Operation continued until the heated cylinder, 10, was emptied of all liquid. No refrigeration cost or equipment was associated with this operation.

### Example 2

### HCFO-1233zd (E) Compared to Other Solvents

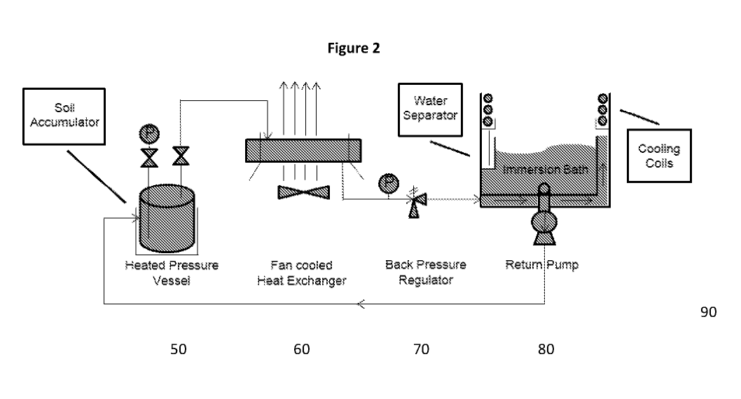

The rate at which clean solvent is returned to the cleaning tank/immersion bath depends on the pressure drop and vapor density of the heated solvent. It is desirable that, regardless of the solvent used, the rate at which it is cleaned by distillation and returned to the cleaning tank/immersion bath should remain constant. In order to compare characteristics of various solvents in a pressurized solvent degreasing system (see FIG. 2), solvent volumetric flow rates can be calculated using the following equations.

$$\begin{matrix}Δ p = \frac{ρ \cdot μ \cdot I \cdot {v}^{2}}{2 d} \\ \begin{matrix}d \text{:} Pipe Inner Diameter ( m ) \\ I \text{:} Pipe Length ( m ) \\ v \text{:} Gas Velocity ( m / s ) \\ Δ p \text{:} Pressure Loss ( Pa ) \\ μ \text{:} Coefficient of friction \\ ρ \text{:} Density of gas ( kg / {m}^{8} ) \\ m = ρ * V * A\end{matrix} \\ Where , \\ \begin{matrix}m = mass flow rate , \\ ρ = density , \\ V = velocity , \\ A = flow area\end{matrix}\end{matrix}$$

Assuming that tubes are of a similar diameter and length, and the coefficient of friction is similar, the mass flow rate of two fluids will be proportional to (ρ·Δp)^{1/2}. Two commonly used degreasing solvents in the market today are HFE-7100 and HFC-43-10mee. Other commonly used degreasing solvents include trichloroethylene (TCE), n-propylbromide, trans-dichloroethylene (DCE) and trans-dichloroethylene blends. Using the data in Table 1, a system running HCFO-1233zd (E) at 50° C. would have a pressure of 43 psi and a (ρ·Δp)^{1/2} value of 26. If HFE-7100 and HFC-43-10mee were desired to have the same solvent return rate as HCFO-1233zd (E) then they would need to be heated to between 80-90° C. (see Table 1). Since HCFO-1233zd (E) can be operated at lower temperatures it brings the advantage of cheaper materials of construction, less opportunity for solvent or soil decomposition and easier handling.

TABLE 1

| HCFO-1233zd (E) | | | | HFE-7100 | | | | HFC-43-10mee | | | |
|---|---|---|---|---|---|---|---|---|---|---|---|
| | | Vapor | | | | Vapor | | | | Vapor | |
| Temp, | Press, | Den, | | Temp, | Press, | Den, | | Temp, | Press, | Den, | |
| ° C. | psi | kg/m³ | (ρ · Δp)^{1/2} | ° C. | psi | kg/m³ | (ρ · Δp)^{1/2} | ° C. | psi | kg/m³ | (ρ · Δp)^{1/2} |
| 10 | 11 | 4.2 | 7 | 10 | 2 | 1.5 | 2 | 10 | 1 | 0.97 | 1 |
| 20 | 16 | 6.1 | 10 | 20 | 3 | 2.3 | 3 | 20 | 2 | 1.7 | 2 |
| 30 | 23 | 8.5 | 14 | 30 | 5 | 3.5 | 4 | 30 | 4 | 2.7 | 3 |
| 40 | 31 | 11.7 | 19 | 40 | 7 | 5.0 | 6 | 40 | 6 | 4.2 | 5 |
| 50 | 43 | 15.7 | 26 | 50 | 10 | 7.0 | 8 | 50 | 9 | 6.4 | 8 |
| 60 | 57 | 20.7 | 34 | 60 | 15 | 9.7 | 12 | 60 | 14 | 9.3 | 11 |
| 70 | 74 | 27.0 | 45 | 70 | 20 | 13.2 | 16 | 70 | 20 | 13.3 | 16 |
| 80 | 95 | 34.8 | 57 | 80 | 27 | 17.5 | 22 | 80 | 28 | 18.6 | 23 |
| 90 | 121 | 44.4 | 73 | 90 | 36 | 23 | 29 | 90 | 39 | 25.5 | 32 |
| 100 | 151 | 56.3 | 92 | 100 | 46 | 29.7 | 37 | 100 | 52 | 34.5 | 42 |

### Comparative Example 1

In a typical solvent degreaser 2 sets of cooling coils are provided. A set of upper coils or freeboard coils are used to remove moisture from the air and prevent any excess loss of solvent. The lower or primary coils are connected to a refrigerant system and have as main function condensing the solvent vapor from the degreasing tank and returning it to a clean rinse tank. The energy required for cooling the primary coils is supplied by a vapor compression refrigeration system which has a capacity greater than the heat supplied in the boil tank/heated cylinder. The degreaser holds 10-15 gal of solvent and the heat supplied to the boil tank requires 1500-2500 watts and therefore the refrigerant capacity in the primary coils is 2500 watts.

### Example 3

### Reduced Energy Degreaser

A system and method of the present invention is operated and incorporates the elements of a pressurized vessel 50, an ambient-air-cooled heat exchanger 60, a condensing manipulator in the form of a back pressure regulator 70, and an immersion bath connected to a return pump, as shown in (FIG. 2). The immersion bath has one set of low capacity coils and a recirculation pump to return soiled solvent back to the soil accumulator/heated pressure vessel. Liquid solvent is heated in the pressure vessel/soil accumulator 50 and vaporized at a temperature and pressure dictated by a back pressure control mechanism, 70. The solvent vapor (minus any high boiling contaminants—which remain in the pressure vessel for later removal) is transferred from the pressure vessel to an air cooled heat exchanger, 60, which condenses the vapor to a liquid phase. The liquid then passes through the back pressure control mechanism, 70, which lowers the pressure and temperature of the system downstream of the valve and allows the solvent to back fill an open-top immersion bath or tank, 80, where high boiling contaminates enter the system during the course of degreasing operations. The returning purified solvent is cooled by passage through a channel, 90, in the subfloor and/or side of the immersion tank, being cooled by the solvent pool in the immersion bath, such that, even though the pressure has been suddenly released to atmospheric by passage through back pressure regulator 70, the majority of the solvent remains in liquid form. Following degreasing operations, the contaminated solvent is pumped from the immersion tank, optionally through a particulate filtration system, back into the pressure vessel/soil accumulator. As additional high boiling contaminates enter the system, the solvent inside the pressure vessel becomes rich in high boiling contaminates due to a flash distillation process taking place. Ambient air is thus effectively used to produce results comparable to Comparative Example 1 but without the use of primary refrigeration coils requiring approximately 1500 to 2500 watts of energy to run. The net energy used to operate the system of the present invention as illustrated in this embodiments is substantially less than the energy required in Comparative Example 1, with a saving approaching, and preferably being about 70% or greater, more preferably 80% or greater and even more preferably 90% or greater of the energy consumed in the primary coils of Comparative Example 1.

### Example 4A

### Degreasing Solvents

Mixtures are prepared including 3 wt % of methanol, 92-96 wt % decafluoropentane (commercially available as VERTREL®), and 1-5 wt % of a glycol ether selected from 2-ethoxyethanol, 2-methoxyethanol, 2-propxyethanol, 2-phenoxyethanol, 2-benzoxy ethanol, methyl carbitol, carbitol cellosolve, diethoxyethane, dimethoxyethane, dibutoxybutane and combinations of any two or more of these. Printed circuit boards are soldered with a number of commercial solder core wires, such as, KESTER 44, ALPHA RELIACORE 15, ALPHA ENERGIZED PLUS and then cleaned in the boiling solvent for 10 min and are removed and dried. These cleaned boards are found to be clean.

### Example 4B

Mixtures are prepared including 3 wt % e of methanol, 92-96 wt % hydrofluoroether (HFE) (commercially available as NOVEC® 7200), and 1-5 wt % of a glycol ether selected from 2-ethoxyethanol, 2-methoxyethanol, 2-propxyethanol, 2-phenoxyethanol, 2-benzoxy ethanol, methyl carbitol, carbitol cellosolve, diethoxyethane, dimethoxyethane, and dibutoxybutane and combinations of any two or more of these. Printed circuit boards are soldered with a number of commercial solder core wires, such as, KESTER 44, ALPHA RELIACORE 15, ALPHA ENERGIZED PLUS and then cleaned in the boiling solvent for 10 min and are removed and dried. These cleaned boards are found to be clean.

### Example 4C

Mixtures were prepared including 3 wt % of methanol and 97 wt % decafluoropentane (commercially available as VERTREL® SFR). This mixture was then combined with glycol ether 2-butoxyethanol such that the blend was provided as 80% and the glycol ether 2-butoxyethanol as 20%. Printed circuit boards were soldered with solder paste ALPHA OM-338PT then cleaned in the boiling solvent for 10 min and were removed and dried. These boards were found to be clean.

### Example 4D

Mixtures were prepared including 3 wt % of methanol and 97 wt % hydrofluoroether (HFE) (commercially available as NOVEC® 7200DA). This mixture was then combined with glycol ether 2-butoxyethanol such that the blend was provided as 80% and the glycol ether 2-butoxyethanol as 20%. Printed circuit boards were soldered with solder paste ALPHA OM-338PT then cleaned in the boiling solvent for 10 min and were removed and dried. These boards were found to be clean.

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for vapor degreasing of articles containing a contaminant comprising:
a) providing a vessel capable of operating under positive pressure;
b) charging said vessel with a liquid solvent containing contaminant;
c) heating the solvent in said vessel to produce vapor containing said solvent at sufficient pressure such that said vapor temperature is from about 30° C. to about 100° C., more preferably from about 50° C. to about 100° C.;
d) condensing said vapor using ambient air; and
(e) using at least a portion of the solvent condensed in step d) to clean the article.

2. The method of claim 1, further comprising the step of releasing the pressure to ambient pressure to collect purified solvent and wherein said condensing step comprises passing said vapor through an ambient-air-cooled heat exchanger.

3. The method of claim 1, wherein said solvent comprises 1-chloro-3,3,3-trifluoropropene.

4. The method of claim 1, wherein said solvent comprises an azeotropic mixture or azeotrope-like mixture comprising 1-chloro-3,3,3-trifluoropropene and an alcohol selected from the group consisting of methanol, ethanol and isopropanol.

5. An energy-efficient method for degreasing or defluxing, comprising:
a) providing a vessel capable of operating under positive pressure;
b) charging said vessel with a liquid solvent comprising 1-chloro-3,3,3-trifluoropropene and contaminant to provide a charged vessel;
c) heating said liquid solvent
d) controlling the pressure of said charged vessel to produce sufficient pressure so that said solvent boils at a temperature of from about 30° C. to about 100° C., more preferably from about 50° C. to about 100° C.;
d) condensing said solvent at a temperature of from about 30° C. to about 100° C., more preferably from about 50° C. to about 100° C. under pressure using ambient air;
e) reducing the pressure on said condensed solvent to provide a depressurized solvent having a lower concentration of contaminant than present in the solvent charged to the vessel in step a);
f) introducing the solvent from step e) in liquid form into an immersion bath; and
g) performing degreasing operations in said immersion bath.

7. The method of claim 8, wherein said solvent comprises an azeotropic mixture or azeotrope-like mixture comprising 1-chloro-3,3,3-trifluoropropene and an alcohol selected from the group consisting of methanol, ethanol and isopropanol.

8. A pressurized solvent degreasing system capable of use with 1-chloro-3,3,3-trifluoropropene, said system comprising:
a) a vessel containing liquid 1-chloro-3,3,3-trifluoropropene and capable of vaporizing at least a portion of said 1-chloro-3,3,3-trifluoropropene to produce a vapor space containing 1-chloro-3,3,3-trifluoropropene at a pressure above atmospheric, connected to
b) an ambient-air-cooled heat exchanger in fluid communication with said vapor space for producing a condensed stream comprising said solvent; connected to
c) a back pressure regulator capable of maintaining the pressure in said vessel at predetermined positive pressure and producing a liquid stream of said condensed solvent at reduced pressure; connected to
d) a degreasing tank comprising an immersion tank, and a subfloor-channel and/or side-channel for receiving said condensed solvent at reduced pressure and introducing said condensed solvent into said immersion tank; wherein said immersion tank is connected to
e) a return pump to deliver at least a portion of solvent from said immersion tank into said vessel a).

9. The degreasing system of claim 8, wherein said positive pressure is about 20 to about 50 psig.

10. The method of claim 1, wherein said solvent low-boiling compound comprises trans1-chloro-3,3,3-trifluoropropene.
